(19) United States
(12) Patent Application Publication
(10) Pub. No.: US 2005/0244680 A1
(43) Pub. Date: Nov. 3, 2005

(54) Environmentally stable metal-evaporated recording media

(75) Inventor: Michael P. Sharrock, St. Paul, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/838,624

(22) Filed: May 3, 2004

(51) Int. Cl. B05D 5/12; B32B 1/00; G11B 5/64

(52) U.S. Cl. 428/836.1; 427/127

(57) ABSTRACT

The invention provides a magnetic recording medium comprising a thin metal magnetic recording layer which is stabilized by pre-oxidation during the deposition process such that in said magnetic recording medium, said magnetic recording layer has an average saturation magnetization intensity less than 350 emu/cm³.

### THE FIELD OF THE INVENTION

The present invention relates generally to advanced metal evaporated recording media, and specifically to metal evaporated recording media which are stabilized by oxidation in the deposition process.

### BACKGROUND OF THE INVENTION

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. The former type of recording media employs metals such as cobalt, cobalt-chromium, cobalt-nickel, cobalt-chromium-platinum, and other cobalt alloys, which are produced by such methods as sputtering and vacuum evaporation.

In media based on a thin metallic magnetic recording layer, such as a magnetic cobalt alloy, the overall media construction will generally include at least the following: 1) a substrate film, 2) a magnetic layer for information recording, 3) optionally, a protective coating such as diamond-like carbon, and 4) a lubricant layer.

It has long been known that introducing oxygen during the deposition process causes the formation of metal oxides, and results in a magnetic recording medium with a higher signal-to-noise ratio. Oxidation is also known to increase the coercivity. However, the introduction of too much oxygen gas has been taught against in the industry, as it reduces the magnetization intensity of the magnetic recording medium.

Previously proposed solutions for improving the coercivity of thin metal layer magnetic media have included increasing the oblique angle of the vapor deposition as disclosed in U.S. Pat. No. 4,540,600; however, this has been taught to reduce the efficiency of the process and to result in a magnetic recording medium having low corrosion resistance.

U.S. Pat. No. 4,385,098 discloses a magnetic recording medium which has a thin metal film magnetic layer formed by the vacuum evaporation process and consisting mainly of Co, Co together with Ni, and the like, which has an oxygen content higher in a surface layer than in a deeper layer below the surface layer so that the magnetic recording medium has a higher coercive force.

Another solution, disclosed in U.S. Pat. No. 5,534,324, involves having high oxygen density areas of the medium using two cobalt magnetic layers. The first magnetic layer is disclosed to have a high oxygen density area which is arranged in the vicinity of the second magnetic layer; and the second magnetic layer has a high oxygen density area which is arranged in the vicinity of the first magnetic layer.

It has now been discovered that introduction of a pre-determined amount of oxygen during the deposition process will pre-age the magnetic recording medium, resulting in stabilization of the magnetic recording medium, and a reduction in the amount of moment loss over the life of the medium. Other benefits may include the fact that the pre-aged medium will be less dependent upon protective coatings, which may be used, if desired, in addition to the oxidative treatment. The pre-aging process will also protect the edges of the magnetic layer, which are difficult or impossible to protect with coatings.

### SUMMARY OF THE INVENTION

The invention provides a thin film metal magnetic recording medium that is stabilized by the use of a high degree of oxidation, beyond that conventionally used, during the deposition process.

Specifically, the invention comprises a thin metal evaporated magnetic recording layer useful for a magnetic recording medium comprising metallic cobalt, said magnetic recording layer having been stabilized by introduction of a predetermined amount of oxygen such that in the magnetic recording medium the magnetic recording layer has an average saturation magnetization intensity less than 350 emu/cm³.

The invention further provides a magnetic recording medium utilizing at least one thin metal magnetic recording layer comprising metallic cobalt and cobalt oxide, said magnetic recording layer(s) having been stabilized by introduction of a predetermined amount of oxygen such that the at least one magnetic recording layer has an average saturation magnetization intensity less than 350 emu/cm³. In some embodiments, the magnetic recording layer has an average saturation magnetization intensity as little as less than 150 emu/cm³.

Such thin metal recording layer(s) preferably have a coercivity of at least about 1800 Oersteds (Oe); in some embodiments, the coercivity is as high as about 2200 Oe.

In another embodiment, the invention provides a thin-film magnetic recording medium including such a pre-aged magnetic layer, where the magnetic recording medium includes no protective coatings.

The invention further comprises a method of manufacture for a magnetic recording medium comprising a thin metal magnetic recording layer, wherein the magnetic recording layer is pre-aged and stabilized by introduction of a predetermined level of oxidation.

These terms when used herein have the following meanings.

1. The term “coating composition” means a composition suitable for coating onto a substrate.

2. The term “saturated magnetization intensity” means the average magnetic moment per unit volume of the coated magnetic layer, in electromagnetic units (emu) per cubic centimeter, abbreviated as emu/cm³, measured at a field strength of 10,000 Oersteds.

3. The term “coercivity” means the intensity of the magnetic field needed to reduce the magnetization of a magnetic material to zero after it has reached saturation, taken at a saturation field strength of 10,000 Oersteds.

4. The term “Oersted,” abbreviated as Oe, refers to a unit of magnetic field intensity.

5. The term “pre-aged” means a metal evaporated layer stabilized by introduction of a predetermined amount of oxygen in the coating process, the amount of oxygen being determined according to the teaching of this patent, whereby the resulting magnetization intensity is lower than that generally practiced in the previous art, for the purpose of achieving greater stability against later loss of magnetization intensity through environmental oxidation or other corrosion.

6. The terms “layer” or “coating” are used interchangeably to refer to a coated composition, which may be the result of one or more evaporative processes and one or more passages through the coating apparatus.

7. The term “lubricant” means a substance introduced between two adjacent solid surfaces, at least one of which is capable of motion, to produce an antifriction effect between the surfaces.

8. The term “protective layer” means a substance applied to the magnetic layer for purposes of protecting it mechanically or chemically, and not primarily as a lubricant.

### DETAILED DESCRIPTION OF THE PREFERRED EMBODIMENTS

The following detailed description describes certain embodiments of the invention and is not to be taken in a limiting sense. The scope of the present invention is defined by the appended claims.

The magnetic recording medium includes a thin metal magnetic recording layer having been stabilized by the exposure of the layer to oxygen during the deposition process.

The various components are described in greater detail below.

### STRUCTURE OF A MAGNETIC RECORDING MEDIUM

A suitable continuous deposition process for the fabrication of a magnetic recording medium involves transportation of a flexible substrate in a longitudinal direction. The substrate which is to be coated with the magnetic recording layer may be any non-magnetic substrate, but is preferably a flexible substrate having a thickness of from about 4 micrometers to about 60 micrometers. Useful substrates include polyethylene terephthalate, polyethylene naphthalate, and polyamide. Sub-layers may be formed on the substrate prior to the deposition of the magnetic recording layer. Either before or after deposition of the magnetic recording layer, a coating that imparts opacity, conductivity, and/or tribological and mechanical properties is generally formed on the side of the substrate opposite that used for recording. After the deposition of the evaporated magnetic coating, a protective nonmagnetic layer may be optionally added, and a lubricant coating is added.

Evaporative Process

The substrate (and any intermediate layers) is transported past a deposition apparatus, which continuously deposits a magnetic layer comprising cobalt, cobalt chrome, cobalt nickel, cobalt chrome platinum, or other cobalt alloys and/or their oxides onto the substrate. The deposition device can be any such device known in the industry including a sputtering apparatus or an electron-beam thermal evaporation apparatus. Preferred methods of deposition include thermal evaporation, which is conducted in a vacuum deposition chamber. The metal vapor is generally introduced over a broad range of incident angles to the substrate surface, and the average angle is typically about 20 degrees to about 60 degrees.

During the vapor deposition process, oxygen is introduced by means of a nozzle, or other introduction means, to allow reactive deposition. Grains of the evaporated metal then form on the surface of the substrate. These metal grains may be coated with metal oxides, may be encased in an oxide matrix, or may be accompanied by grains of oxide composition. Oxygen is introduced at a predetermined flow rate, which will depend upon the exact properties desired, and also the width and transport speed of the substrate. By introducing oxygen at such a predetermined rate, the magnetization intensity of the resulting magnetic recording medium is reduced, and the coercivity is increased. This stabilizes the magnetic recording medium against further corrosion (e.g., oxidation) in use and storage. The thickness of the magnetic layer (or layers) is typically between 0.025 micrometers and 0.5 micrometers.

Subsequent Steps

After deposition of the magnetic layer(s), an optional protective coating of, for example (but not limited to), diamond-like carbon may be deposited by a suitable method. This may be done for protection against corrosion or for increased durability, or both. The magnetic recording medium formed according to the invention is capable of decreasing the need for such a protective coating. If desired, useful protective layers may include such materials as diamond-like carbon layers, SiC layers, amorphous carbon, nitrogenated or hydrogenated amorphous carbon, or silicon nitride.

When the magnetic layer(s) and any optional protective layer(s) have been coated, finishing processes such as polishing or burnishing may be performed

The lubricant is applied by conventional methods. For example, the lubricant compound may be dissolved in a solvent, and the thin film medium dipped in the lubricant solution for a sufficient time to allow the solution to contact the surface and then drained, or the lubricant solution may be pumped over the recording medium and then allowed to drain. The lubricant may be any conventional lubricant known in the industry, e.g., a fluorinated hydrocarbon, or, more specifically, a fluorinated polyether.

Resulting Properties

Magnetic recording media formed according to the invention comprise magnetic layers that have average saturation magnetization intensities less than about 350 emu/cm³, and, in some embodiments, the average saturation magnetization intensity may be less than about 150 emu/cm³. Coercivity of the magnetic recording medium formed according to the invention is at least 1800 Oe, and, in some embodiments, the coercivity of the magnetic recording medium may be as high as at least about 2200 Oe.

Magnetic recording media stabilized by the evaporation and oxygen introduction process described above exhibit less aging (as measured by magnetic moment loss) over time or during archival storage stability tests, in which they are exposed to heat and humidity, which accelerates the effects of time in a normal environment. Magnetic recording media made with magnetic recording layers formed according to this invention show a slower initial magnetic moment loss than do those magnetic recording media made according to conventional teachings. Without wishing to be bound by theory, it is believed that the rapid initial oxidation has been preempted by the oxidation taking place in the evaporative coating process. Increasing somewhat the thickness of the magnetic layer(s) can compensate for the resulting lower initial magnetization intensity. Conventional media show magnetic moment loss up to about 30% over eight weeks of an archival storage test, largely because of their rapid initial loss. The magnetic moment loss seen in aging of any evaporated metal recording medium will depend on a number of factors, especially the thickness of the magnetic layers, but media prepared according to this invention will show less moment loss than comparable media prepared according to conventional teachings.

Due to the stabilization effects of the deposition/evaporation process used, the magnetic recording media manufactured according to the invention process may not require the addition of a protective top layer over the magnetic recording layer.

1. A thin-film magnetic recording medium including at least one pre-aged magnetic layer comprising metallic cobalt, said magnetic recording layer having been stabilized by introduction of a predetermined amount of oxygen whereby said magnetic recording layer has an average saturation magnetization intensity less than 350 emu/cm³.

2. A thin metal evaporated magnetic recording medium including at least one pre-aged layer according to claim 1 having an average saturation magnetization intensity less than 300 emu/cm³.

3. A thin metal evaporated magnetic recording medium including at least one pre-aged layer according to claim 1 having an average saturation magnetization intensity less than 250 emul/cm³.

4. A thin metal evaporated magnetic recording medium including at least one pre-aged layer according to claim 1 having an average saturation magnetization intensity less than 200 emu/cm³.

5. A thin metal evaporated magnetic recording medium including at least one pre-aged layer according to claim 1 having an average saturation magnetization intensity less than 150 emu/cm³.

6. A thin metal evaporated magnetic recording medium including at least one pre-aged layer according to claim 1 having a coercivity greater than 1800 Oe.

7. A thin metal evaporated magnetic recording medium including at least one pre-aged layer according to claim 2 having a coercivity greater than 1800 Oe.

8. A thin metal evaporated magnetic recording medium including at least one pre-aged layer according to claim 3 having a coercivity greater than 1800 Oe.

9. A thin metal evaporated magnetic recording medium including at least one pre-aged layer according to claim 4 having a coercivity greater than 1800 Oe.

10. A thin metal evaporated magnetic recording medium including at least one pre-aged layer according to claim 5 having a coercivity greater than 1800 Oe.

11. A thin metal evaporated magnetic recording medium including at least one pre-aged layer according to claim 2 having a coercivity greater than about 1900 Oe.

12. A thin metal evaporated magnetic recording medium including at least one pre-aged layer according to claim 3 having a coercivity greater than about 2000 Oe.

13. A thin metal evaporated magnetic recording medium including at least one pre-aged layer according to claim 4 having a coercivity greater than about 2100 Oe.

14. A thin metal evaporated magnetic recording medium including at least one pre-aged layer according to claim 5 having a coercivity greater than about 2200 Oe.

15. A thin metal evaporated magnetic recording medium comprising a thin metal pre-aged magnetic recording layer comprising metallic cobalt, said magnetic recording layer having been stabilized by introduction of a predetermined amount of oxygen, said medium having a loss of saturated magnetic moment of less than about 30% after exposure of the unprotected magnetic recording medium formed from said layer to an environment of 65 degrees C. and 90% relative humidity for eight weeks.

16. A thin metal evaporated magnetic recording medium according to claim 15 having a loss of saturated magnetic moment of less than 20% after exposure of the unprotected magnetic recording medium formed from said layer to an environment of 65 degrees C. and 90% relative humidity for eight weeks.

17. A thin metal evaporated magnetic recording medium according to claim 15 having a loss of saturated magnetic moment of less than 10% after exposure of the unprotected magnetic recording medium formed from said layer to an environment of 65 degrees C. and 90% relative humidity for eight weeks.

18. A thin-film evaporated magnetic recording medium including at least one pre-aged magnetic layer, said layer having been stabilized by the introduction of a predetermined amount of oxygen, wherein the magnetic recording medium includes no protective coatings.

19. A method of manufacture for a magnetic recording medium comprising at least one pre-aged thin metal magnetic recording layer, wherein the magnetic recording layer is pre-aged and stabilized by introduction of a predetermined level of oxygen.

20. A method of manufacture according to claim 19 wherein said magnetic recording layer has an average saturation magnetization intensity less than 350 emu/cm³.
